(19) United States
(12) Patent Application Publication
(10) Pub. No.: US 2003/0044992 A1
(43) Pub. Date: Mar. 6, 2003

(54) Cell-based multiplexing ADME analysis using focused fluid flow

(76) Inventors: Anthony C. Chao, Cupertino, CA (US); Martin Kirk, San Carlos, CA (US)

Correspondence Address: REED & ASSOCIATES, 800 MENLO AVENUE, SUITE 210, MENLO PARK, CA, 94025, US

(21) Appl. No.: 09/945,360

(22) Filed: Aug. 31, 2001

(51) Int. Cl. G01N 35/08

(52) U.S. Cl. 436/52; 436/63; 422/68.1; 422/81; 422/102; 435/4; 435/29

(57) ABSTRACT

The invention relates to methods and devices for conducting multiplex assays for determining absorption, distribution, metabolism, and/or excretion (ADME) properties of an analyte. The method and device provide the ability to study analytes by controllably flowing, in laminar flow, an analyte in an analyte stream over a substrate having a plurality of substantially parallel individual test lanes on the surface thereof, wherein each test lane comprises a plurality of living cells immobilized therein. Changes, when present, in the analyte, the cells, or both, are detected and thereafter correlated to an ADME property of the analyte.

### TECHNICAL FIELD

The present invention relates to methods and devices for conducting assays to determine absorption, distribution, metabolism, and/or excretion (ADME) properties of an analyte. More specifically, the invention relates to methods and devices that provide for such assays based on delivering a fluid containing the analyte to cells, wherein the analyte-containing fluid is maintained in laminar flow.

### BACKGROUND

Demonstrating that a proposed drug is both safe and therapeutically effective in humans is a challenging, complex, and expensive process. Once discovered, a new chemical entity must face a battery of preclinical screening tests. In this way, evaluations may be made concerning how a living system reacts to the new chemical entity before exposing the new chemical entity to humans. This barrage of testing is expensive in terms of time and money, as these tests require expert personnel to initially conduct and then interpret the test results. Moreover, the tests require large amounts of materials or expensive processes, thereby further increasing the cost. Often, promising new chemical entities proceed through much of this screening gauntlet only to be abandoned once an insurmountable negative characteristic is identified. When new chemical entities are abandoned, it is not uncommon that an investment of several million dollars is lost.

Consequently, efforts have been directed at reducing these costs by developing less expensive and more efficient models that are more predictive of clinical efficacy. For example, traditional systemic absorption study might involve administering a new compound to an experimental subject, e.g., a mouse, and subsequently obtaining blood samples. These blood samples must be analyzed in order to determine the presence of the compound and its level in the subject. Although an effective method for screening new compounds, traditional studies are costly in terms of time and money as the experimental subjects must be obtained and cared for, the compounds must be administered according to strict guidelines, and the samples obtained must be analyzed. Furthermore, testing live experimental subjects can be controversial, and avoidance of this approach in research, if possible, is generally encouraged.

More recent assays have used models based on cells, tissues, or entire organs. These approaches have offered advantages over the experimental testing of living animals. Cells, for example, can be manipulated so as to continuously reproduce, thereby ensuring a steady and identical supply of cells. Tissue and organ systems can be recovered from slaughterhouses or other means. U.S. Pat. No. 5,989,918 to Dietz et al. discusses using animal or organ models perfused with a blood substitute for performing an ADME analysis. Such models, however, require sophisticated techniques for removing, preserving, and maintaining the organ in a state adequate for testing, thereby increasing costs and complexity.

Furthermore, assays based on cell, tissue, or organ models do not lend themselves to screening large numbers of compounds. For example, U.S. Pat. No. 5,728,576 to Dudley et al. discusses placing cells on a series of cover slips, each of which is placed on a support device. The support device is then submerged in a solution and thereafter analyzed to determine properties. Although serially increasing the concentration of the same drug is discussed, the method does not provide for the ability to conduct multiplexed assays wherein different analytes may be tested.

Newer techniques have been suggested that use computer modeling. Such techniques are held out as offering the ability to screen large numbers of compounds based on data sets. These data sets are derived from numerous experiments based on, for example, absorption studies; drug transporters and efflux pumps, e.g., P-glycoprotein (P-gp) and multiple drug resistance-associated protein (MRP) studies; intrinsic clearance studies; and brain penetration evaluations. See Ekins et al. (2000) J. Pharmacol Toxicol Methods 44(1):251-272. These “in silico” assays, however, are often rudimentary, provide incomplete or even incorrect data, and still require conventional screening methods to back up or support conclusions.

Thus, there is a need for alternative methods and devices that can conduct assays to determine the absorption, distribution, metabolic, and/or excretion (ADME) properties of an analyte, such as a new chemical entity. The method and device allow for the ability to conduct such assays with relatively high throughput, without the great amount of effort and expense commonly seen with conventional testing methods. The method and device do not require large amounts of cells or other reagents for effectiveness, which could increase testing costs.

### SUMMARY OF THE INVENTION

Accordingly, it is an object of the present invention to overcome the above-mentioned disadvantages of the prior art by providing methods for conducting multiplex assays to determine the absorption, distribution, metabolism, and/or excretion, (hereinafter referred to as “ADME”) properties of an analyte by: (a) providing a device comprising (i) a substrate having a plurality of substantially parallel individual test lanes on the surface thereof, wherein each test lane comprises a plurality of living cells immobilized therein, and the living cells within any one test lane are the same; (ii) at least one inlet for introduction of a carrier fluid into the device; (iii) a means for controlling delivery of the carrier fluid into and across the substrate surface; and (iv) an analyte source for introducing the analyte into the carrier fluid; (b) introducing the analyte from the analyte source to at least one test lane by controlled delivery of a carrier fluid containing the analyte so that the analyte is maintained by laminar flow within a predetermined flow path, thereby contacting the living cells immobilized in at least one of the test lanes; (c) detecting a change, when present, in the immobilized cells, the analyte, or both, resulting from the contact; and (d) correlating any change detected in (c), or lack thereof, to an ADME property of the analyte.

It is another object of the invention to provide such a method carried out with multiple analytes.

It is still another object of the invention to provide such a method carried out with a single analyte.

Another object of the invention is to provide such a method wherein the carrier fluid containing the analyte flows in a direction substantially perpendicular to the test lanes.

Still another object of the invention is to provide such a method wherein the carrier fluid containing the analyte flows in a direction substantially parallel to the test lanes.

It is still yet another object of the invention to provide such a method wherein the carrier fluid comprises a medium appropriate to sustain living cells.

It is still another object of the invention to provide a device for carrying out the method, wherein the device comprises: (a) a substrate having a plurality of substantially parallel individual test lanes on the surface thereof, wherein each test lane comprises a plurality of living cells immobilized therein, and the living cells within any one test lane are the same; (b) at least one inlet for introducing a carrier fluid into the device so as to enable contact between the carrier fluid and the substrate surface; (c) an analyte source for introducing the analyte into the carrier fluid; (d) a means for controlling delivery of the carrier fluid so as to enable the analyte to be maintained by laminar flow within a predetermined flow path, thereby providing for contact of the living cells immobilized in at least one of the test lanes; and (e) at least one outlet enabling removal of fluid from the device.

It is a further object of the invention to provide such a device that includes a means for detecting a change in the immobilized cells, the analyte, or both resulting from the contact of the living cells with the analyte.

Additional objects, advantages, and novel features of the invention will be set forth in part in the description that follows, and in part will become apparent to those skilled in the art upon examination of the following, or may be learned through routine experimentation upon practice of the invention.

In one embodiment, the invention provides a method for conducting a multiplex assay for determining ADME properties. Thus, the invention is directed to better understanding what a biological system will do when exposed to an analyte. The information derived from the determination of the behavior of a biological system in response to exposure of an analyte corresponds to the ADME properties of the analyte in the system, and, by extension, in a living organism. These properties are sometimes referred to as pharmacokinetic properties, and the terms “ADME” and “pharmacokinetic” are interchangeable for purposes of the present discussion.

In a first step of the method, a device is provided comprising (i) a substrate having a plurality of substantially parallel individual test lanes on the surface thereof, wherein each test lane comprises a plurality of living cells attached therein, and the living cells within any one test lane are the same; (ii) at least one inlet for introduction of a carrier fluid into the device; (iii) a means for controlling delivery of the carrier fluid into and across the substrate surface; and (iv) an analyte source for introducing the analyte into the carrier fluid.

The next step includes the introduction of the analyte from the analyte source to at least one test lane. The analyte is released into the carrier fluid and carried to at least one test lane by controlled delivery of the analyte-containing carrier fluid so that the analyte is maintained by laminar flow within a predetermined flow path, thereby contacting the living cells immobilized in at least one of the test lanes. The third step comprises detecting a change, when present, in the immobilized cells, the analyte, or both, resulting from the contact of the analyte with the cells. The final step requires correlating any change detected in the third step, or lack thereof, to an ADME property of the analyte.

There are a number of different techniques that can be employed to carry out the multiplex technique. One technique involves testing the same analyte against each test lane wherein each test lane contains a different assay. For example, the same analyte may be directed over different test lanes containing different cell types. The terms “different cell types” and “different cells” are used interchangeably and refer to differentiated cells, e.g., hepatocytes, nerve cells, endothelial cells, as well as the cells that are only distinguishable from each other by, for example, disease state (e.g., virally infected white blood cells and non-infected white blood cells) or cell treatment (e.g., cells that have been treated with different pH solutions or reagents including endothelial cells incubated with a control solution and endothelial cells incubated with a solution containing tumor necrosis factor). The analyte-containing fluid is then directed over each test lane, thereby allowing the analyte to contact each cell type within the test lane. This technique provides the ability to test the same analyte against different parameters, thereby providing a facile means for quickly testing many characteristics of a single analyte.

Another technique involves testing different analytes against identical test lanes wherein each test lane contains the same assay, i.e., the same exact cell type. For example, a substrate is prepared wherein each test lane has gastrointestinal cells immobilized therein. A first analyte-containing fluid is directed over a first lane, a second analyte-containing fluid is directed over a second lane, a third analyte-containing fluid is directed over a third lane, and so on. In this technique, the fluid flows and the test lanes run parallel to each other. This technique provides the ability to test the same characteristic, e.g., metabolism of the analyte, for a large number of different analytes.

The techniques may be combined, i.e., testing several compounds against several different assays. Although such testing can be performed in a number of ways, a preferred method is to provide a series of different cell types in separate test lanes and direct a series of different analytes such that the flow of carrier fluid is perpendicular to the test lanes and each analyte is allowed to contact cells within each test lane in a narrow cross-sectional area. Of course, other arrangements are possible that are readily identifiable by one of ordinary skill in the art.

In another embodiment, the invention provides a device for conducting multiplex assays for determining ADME properties. The device comprises a means for conducting a multiplex assay for determining ADME properties of an analyte, comprising: (a) a substrate having a plurality of substantially parallel individual test lanes on the surface thereof, wherein each test lane comprises a plurality of living cells immobilized therein, and the living cells within any one test lane are the same; (b) at least one inlet for introducing a carrier fluid into the device so as to enable contact between the carrier fluid and the substrate surface; (c) an analyte source for introducing the analyte into the carrier fluid; (d) a means for controlling delivery of the carrier fluid so as to enable the analyte to be maintained by laminar flow within a predetermined flow path, thereby providing for contact of the living cells immobilized in at least one of the test lanes; and (e) at least one outlet enabling removal of fluid from the device. The device may further comprise a means for detecting a change, when present, in the immobilized cells, the analyte or both.

### BRIEF DESCRIPTION OF THE DRAWINGS

FIG. 1 illustrates a device in exploded view schematically showing many features of the device as described herein.

FIGS. 2A-2D, collectively referred to as FIG. 2, illustrate a preferred device that may be employed to carry out the inventive method by directing a hydrodynamically focused stream over a target region of a substrate surface. FIG. 2A illustrates the device in exploded view. FIGS. 2B-2D schematically illustrate the device in assembled form, wherein a reagent lane formed from a hydrodynamically focused stream is swept over a target region of a substrate surface from one side wall to an opposing side wall.

FIGS. 3A and 3B, collectively referred to as FIG. 3, illustrate another device that may be employed to carry out the multiplex assays of the present invention. FIG. 3A illustrates the device in exploded view. FIG. 3B schematically illustrates the device in an assembled form and in operation.

FIGS. 4A and 4B, collectively referred to as FIG. 4, illustrate a device similar to that illustrated in FIG. 3 except that an analyte-containing matrix is provided upstream from a target region. FIG. 4A illustrates the device in exploded view. FIG. 4B schematically illustrates the device in an assembled form.

### DETAILED DESCRIPTION OF THE INVENTION

Before the invention is described in detail, it is to be understood that, unless otherwise indicated, this invention is not limited to particular materials, components, or manufacturing processes, as such may vary. It is also to be understood that the terminology used herein is for purposes of describing particular embodiments only, and is not intended to be limiting.

It must be noted that, as used in the specification and the appended claims, the singular forms “a,” “an,” and “the” include plural referents unless the context clearly dictates otherwise. Thus, for example, reference to “a test lane” includes a single test lane as well as a plurality of individual test lanes, reference to “an inlet” includes a single inlet as well as to a plurality of inlets, and the like.

In this specification and in the claims that follow, reference will be made to a number of terms that shall be defined to have the following meanings:

The term “cell line” as used herein refers to a permanently established cell culture that will proliferate indefinitely given appropriate fresh medium and space. While cell lines are readily available for some species such as those in the rodent family, and difficult to establish for other species such as humans, the term “cell line” as used herein is not limited to any particular species or cell type.

The term “fluid-tight” is used herein to describe the spatial relationship between two solid surfaces in physical contact such that fluid is prevented from flowing into the interface between the surfaces.

The terms “immobilize,” “immobilized”, and “immobilizing,” e.g., as in “immobilized cells,” are used herein to describe the fixation of a cell to a position on a substrate surface.

The term “laminar flow” as used herein refers to fluid movement in the absence of turbulence, such that mixing of fluid components occurs solely or primarily as a result of diffusion. The Reynolds number associated with laminar flow described herein is typically about 0.1 to about 200, preferably about 1 to 20, and optimally about 2 to 10.

The term “individual test lane” as used herein refers to an area, usually approximating a rectangular area, on the surface of a substrate where a plurality of cells is immobilized, either directly or indirectly.

An “analyte stream” or “analyte lane” is one of a set of typical routes or courses along which a carrier fluid containing an analyte travels or moves. The analyte stream or lane may be bounded by one or more solid surfaces or by a carrier stream not containing any analyte.

“Optional” or “optionally” as used herein means that the subsequently described feature or structure may or may not be present, or that the subsequently described event or circumstance may or may not occur, and that the description includes instances where a particular feature or structure is present and instances where the feature or structure is absent, or instances where the event or circumstance occurs and instances where it does not.

The term “primary cell” is used herein in its ordinary sense and refers to a cell taken directly from a living tissue that has not been immortalized. Primary cells may be derived from a number of sources such as from an in vivo or ex vivo organ culture. For example, primary cells may be taken from a liver biopsy, a fetus, or embryonic tissue.

The term “analyte” is used herein to refer to any substance on which one or more ADME properties is determined. Thus, for example, the analyte may be a drug, a drug candidate, a pharmaceutical excipient, a pharmaceutical excipient candidate or an experimental reagent (e.g., inducers and/or inhibitors of different cytochrome P450 isoenzymes). Typically, the analyte is a small drug molecule, amino acid, amino acid analog, peptide, protein, nucleotide, nucleoside, oligonucleotide, antibody, or a conjugate (e.g., chemical conjugate) thereof.

The term “substrate” as used herein refers to any material having a surface over which laminar fluid flow may occur. The substrate may be constructed in any of a number of forms such as wafers, slides, well plates, and membranes. Suitable substrate materials include, but are not limited to, supports that are typically used for cell handling such as: polymeric materials (e.g., polystyrene, polyvinyl acetate, polyvinyl chloride, polyvinyl fluoride, polyacrylonitrile, polyacrylamide, polymethyl methacrylate, polytetrafluoroethylene, polyethylene, polypropylene, polybutylene, polyvinylidene fluoride, polycarbonate, polyimide, and polyethylene teraphthalate); silica and silica-based materials; functionalized glasses; ceramics; and substrates treated with surface coatings, polymeric, and/or metallic compounds, or the like. While the foregoing support materials are representative of conventionally used substrates, it is to be understood that the substrate may in fact comprise any biological, nonbiological, organic, and/or inorganic material, and may further have any desired shape, such as a disc, square, sphere, circle, etc. The substrate surface is typically, but not necessarily, flat, e.g., the surface may contain raised or depressed regions.

The term “surface modification” as used herein refers to the chemical, biological, and/or physical alteration of a surface by an additive or subtractive process to change one or more chemical and/or physical properties of a substrate surface or a selected location or region of a substrate surface. For example, surface modification may involve (1) changing the wetting properties of a surface, (2) functionalizing a surface, i.e., providing, modifying, or substituting surface functional groups, (3) defunctionalizing a surface, i.e., removing surface functional groups, (4) otherwise altering the chemical composition of a surface, e.g., through etching, (5) increasing or decreasing surface roughness, (6) providing a coating on a surface, e.g., a coating that exhibits wetting properties that are different from the wetting properties of the surface, and/or (7) depositing particulates on a surface. Thus, for example, surface modification may involve providing a biologically derived coating on a surface, wherein the coating comprises a naturally occurring polymer such as a protein or peptide (such as collagen, fibronectin, albumin, fibrinogen, or thrombin), saccharide (such polymannuronic acid, polygalacturonic acid, dextran, or glycoaminoglycan), or a synthetic polymer (such as polyvinyl alcohol, acrylic acid polymers, or acrylic acid copolymers).

The term “target region” as used herein refers to a predefined two-dimensional area encompassing the test lanes and over which fluid is directed to flow. The target region is typically, but not necessarily, contiguous and may or may not have cells adhered thereto. The target region may exhibit any of a variety of surface properties as long as the surface properties are predetermined.

Thus, the invention generally relates to methods and devices for conducting multiplex assays for determining ADME properties. As stated above, multiplex assays encompass the ability to test a large number of different analytes for the same characteristic, a single analyte for a large number of different characteristics, or some combination of the two. Although not limited with respect to the particular arrangement used, the methods and devices provide the ability to conduct a relatively large number of separate tests (either directed to the same or to different analytes). Thus, the present methods and devices can perform more than about 10 different tests, preferably more than about 40 separate tests, and most preferably more than about 100 different tests, e.g., when 10 different analytes are exposed to 10 different cell types. Generally, although not necessarily, no more than about 500 to 1000 different tests are performed in any individual round of testing. Additional rounds of testing may be performed in order to test additional analytes and/or the same analyte against test lanes containing different cells.

Generally, the method involves and the device provides for controlled delivery of a fluid containing the analyte such that the fluid is maintained in laminar flow through a predetermined flow path.

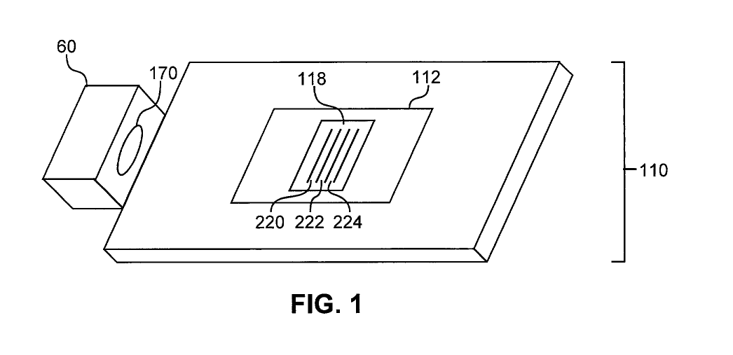

As illustrated in FIG. 1, the device 110 includes a substrate 112. Although not limited with respect to shape or material, the substrate 112 included in device 110 is preferably an ordinary glass slide, e.g., a 25 mm×75 mm glass slide or a 50 mm×75 mm glass slide. The substrate 112 represents at least a portion of a predetermined flow path (not shown) when flow is initiated over the substrate 112. As illustrated, the substrate 112 includes a plurality of individual test lanes 220, 222, and 224, although the substrate 112 preferably includes many more test lanes than shown in FIG. 1. Each individual test lane 220, 222, and 224 is arranged such that all test lanes are substantially parallel to each other. The individual test lanes 220, 222, and 224 may be arranged such that the lanes are substantially parallel or perpendicular (as shown) to fluid flow during operation. Individual test lanes 220, 222, and 224 comprise a plurality of living cells (not shown) immobilized therein, and the living cells within any one test lane are of the same type. The cells within each individual test lane 220, 222, and 224 are preferably located such that the flow of fluid, either with or without analyte, will pass over each individual test lane 220, 222, and 224 and the substrate 112. The individual test lanes 220, 222, and 224 are located in the target region 118 over which fluid will flow in a predetermined flow path. The surface area of the target region 118 is typically 1 mm² to about 100 mm², preferably is about 10 mm² to about 50 mm², and optimally about 20 mm² to about 30 mm². Advantageously, target regions of this size reduce the volume of reagent and/or the quantity of cells required for the multiplex assays described herein.

The device 110 also comprises at least one inlet 170 for introducing a carrier fluid (not shown) containing an analyte (also not shown) into the device 110, thereby allowing for the carrier fluid to contact the substrate surface once flow is initiated.

The device 110 also comprises a controlled delivery means 60 for delivering the carrier fluid in a controlled and directed manner over the substrate 112. Any effective controlled delivery means may be used to deliver the carrier fluid in a controlled and directed manner. In operation, the controlled delivery means 60 and analyte source (not shown in FIG. 1) cooperatively function so as to controllably deliver an analyte in a carrier fluid to at least one test lane. Examples of the controlled delivery means and analyte source working cooperatively to deliver a fluid containing an analyte are described below.

One technique for effecting controlled delivery of a fluid containing an analyte involves directing a hydrodynamically focused stream of fluid over the target region. Use of hydrodynamic focused streams in cellular assays has been described, for example, in U.S. Ser. No. 09/896,484 (“Flow Cell Assemblies and Methods of Spatially Directed Interaction Between Liquids and Solid Surfaces”), inventors Martin Bonde and Thomas Ahl, filed on Jun. 29, 2001; and aspects of hydrodynamics focusing described in that application may be employed in the present invention as well.

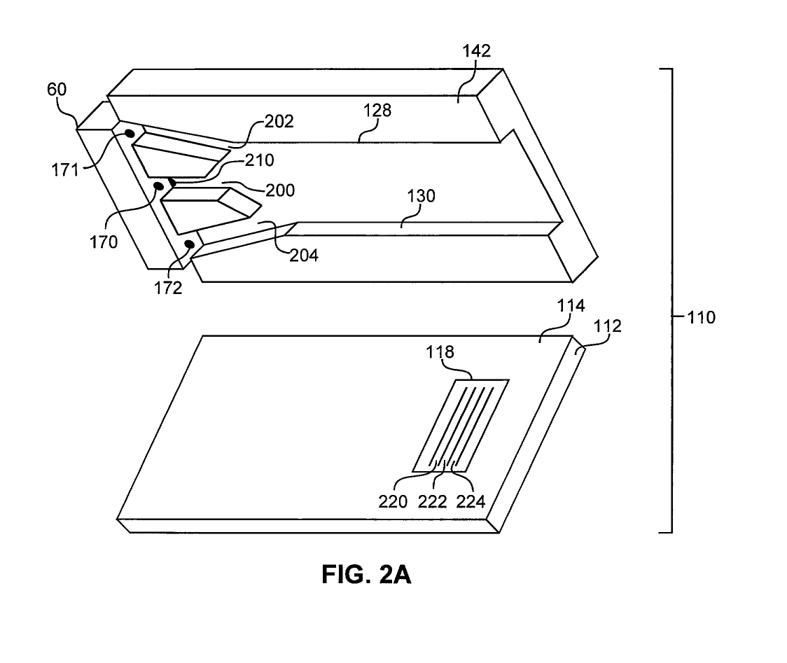

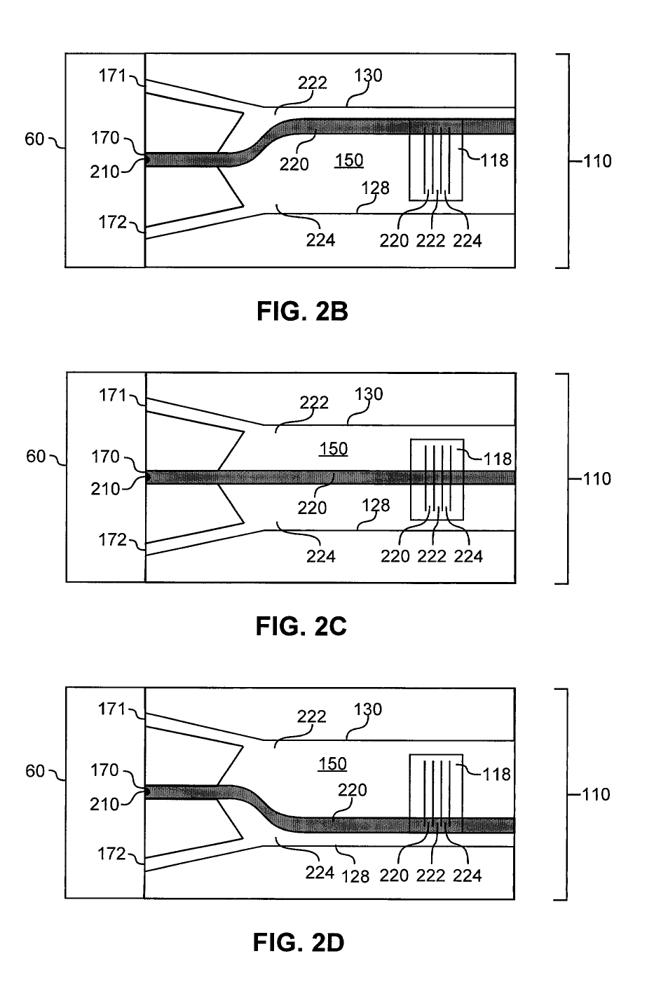

FIG. 2A illustrates a device that may be employed to provide controlled delivery, wherein the controlled delivery is effected by a hydrodynamically focused stream over the target region. At least three introduction channels are provided in connection with the controlled delivery means 60. That is, an analyte stream channel 200 including an analyte source 210 is provided between two guide stream channels, indicated at 202 and 204, on an optional cover plate contact surface 142, such that when the cover plate contact surface 142 is placed in contact with substrate surface 114, channels 200, 202, and 204 form introduction conduits each having an inlet indicated at 170, 171, and 172 through which fluid external to the microdevice may flow, emptying into the main flow passage 150. As shown, guide stream inlets 171 and 172 are located at the most upstream position near sidewalls 128 and 130.

In operation, as illustrated in FIGS. 2B, 2C and 2D, the device is assembled to form the main flow passage 150 defined by the substrate, the side walls 128 and 130, and the ceiling of the main channel. The target region 118 is located within the main flow passage 150 downstream from the introduction conduits and associated inlets 170, 171, and 172. In this approach for providing controlled delivery, the controlled delivery means 60 provides guide stream inlets in fluid communication with a guide fluid source and an analyte inlet is provided fluid communication with an analyte source 210 containing the analyte. When fluid flow is provided from the sources and through inlets 170, 171, and 172, a lane of analyte 220 is formed between two lanes 222 and 224 of guide fluids. Generally, the width of the analyte lane is a function of the volumetric flow rate of the fluid in the analyte lane and the flow rate of the guide streams. That is, a low analyte fluid flow rate in combination with a high guide stream flow rate tends to result in a narrow analyte lane. Conversely, a high analyte fluid flow rate in combination with a low guide stream flow rate tends to result in a wide analyte lane.

In addition, the position of the analyte lane depends on the relative flow rate of the fluids in the guide lane. For example, FIG. 2B illustrates the position of the analyte lane when the volumetric flow rate of the fluid in lane 224 is substantially greater than that of the fluid in lane 222. FIG. 2C illustrates the position of the analyte lane when the volumetric flow rates of the fluids in lanes 222 and 224 are approximately equal. FIG. 2D illustrates the position of the analyte lane when the volumetric flow rate of the fluid in lane 224 is substantially lower than that of the fluid in lane 222. It should be evident, then, that it is possible to direct the hydrodynamically focused analyte stream 220 from side wall 130 to side wall 128, thereby ensuring that the analyte stream 220 can be directed over any desired point of the target region 118. This is accomplished by increasing the flow rate of fluid in lane 222 to the flow rate of fluid in lane 224. Similarly, a hydrodynamically focused stream of reagent may be directed from side wall 128 to side wall 130, and over any point of the target region 118, by increasing the flow rate of fluid in lane 224 to the flow rate of fluid in lane 222. Although the same analyte may be directed over the entire test region 118, it is preferred that the analyte source 210 serially or intermittently introduce different analytes. In this way, each analyte is tested against the entire battery of tests provided by test lanes 220, 222, and 224 when the test lanes 220, 222, and 224 are arranged perpendicular to the fluid flow as shown.

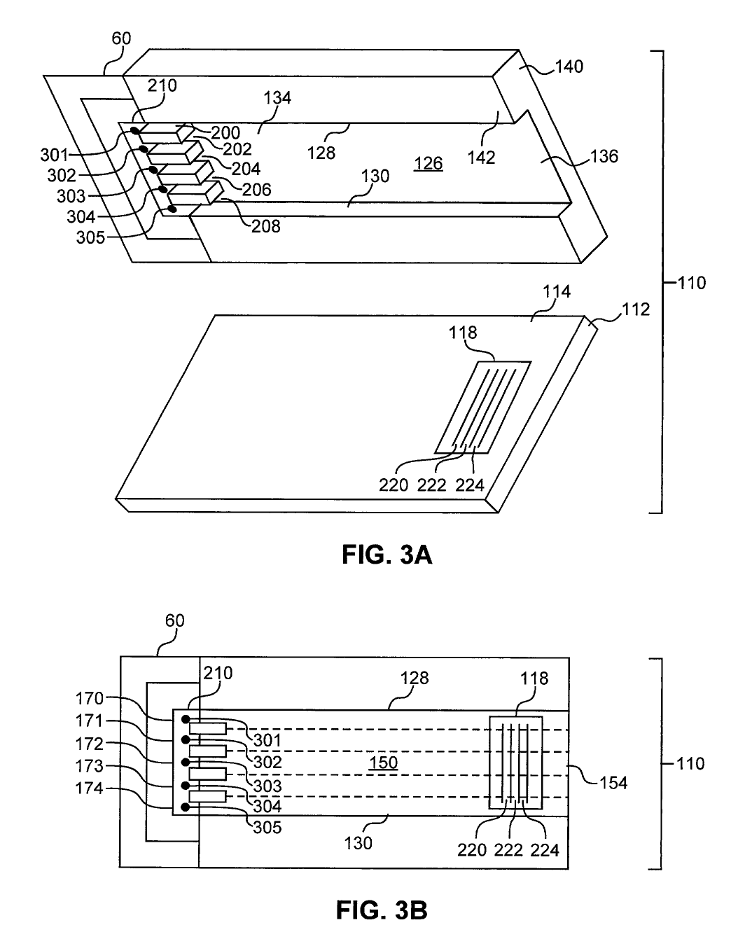

Another technique for effecting controlled delivery of a fluid containing an analyte is illustrated in FIG. 3. A similar device that uses the same delivery means is described in U.S. Ser. No. ______ (“Method for Conducting Cell-Based Analyses Using Laminar Flow, and Device Therefor”), inventors David Socks and Thomas Ahl, filed on Aug. 28, 2001, as well. As illustrated in FIG. 3A, the device 110 includes a substrate 112 having a target region 118 located on surface 114. The device 110 also includes an optional cover plate 140 having a main channel 126 located on the first surface 142 as defined by opposing side walls 128 and 130. The main channel 126 has an inlet terminus 134 at a first end and an outlet terminus 136 at the opposing end. As shown in FIG. 3A, terminus 134 is located away from the exterior edges of the first cover plate surface 142, whereas terminus 136 is located at an edge of the first cover plate surface 142. The controlled delivery means 60 includes a plurality of introduction channels, in order indicated at 200, 202, 204, 206, and 208, extending from the exterior edge opposing the main channel outlet terminus 136, to the inlet terminus 134. The controlled delivery means also includes the analyte source 210 comprising individual analyte outlets 301, 302, 303, 304, and 305. Additional or fewer introduction channels and analyte outlets may be incorporated in the methods and devices described herein.

The contact surface 142 of the cover plate 140, is typically capable of interfacing closely with the contact surface 114 of the substrate 112 to achieve fluid-tight contact between the surfaces. The substrate contact surface 114 in combination with the ceiling and the side walls 128 and 130 of the channel 126 define a main flow passage 150 through which fluids may flow. Similarly, the substrate contact surface 114 in combination with introduction channels 200, 202, 204, 206, and 208 form introduction conduits each having an inlet indicated at 170, 171, 172, 173, and 174 through which fluid external to the microdevice may flow, emptying into the main flow passage 150. Outlet 154 is located at the downstream end of the flow passage. The introduction conduits are typically, although not necessarily, in fluid communication with a plurality of fluid sources.

In operation, as illustrated in FIG. 3B, the device is assembled to form the main flow passage 150 defined by the substrate, the side walls 128 and 130, and the ceiling of the main channel. The target region 118 is located within the main flow passage 150 downstream from the introduction conduits and associated inlets 170, 171, 172, 173, and 174. As shown, the inlets are positioned in a line perpendicular to the flow passage and parallel to the substrate surface. Each inlet is provided fluid communication with a fluid source. Fluid flows from the controlled delivery means 60 and is joined with analyte source 210 comprising analyte outlets 301, 302, 303, 304, and 305, making it possible to maintain each of the fluids in contiguous laminar flow through the flow passage to form fluid lanes, whose boundaries are indicated by dotted lines, extending from each of the inlets 170, 171, 172, 173, and 174 over at least a portion of the target region 118. Each fluid lane that is formed can then pass over a single individual test lane (e.g., when the individual test lanes 220, 222, and 224 run parallel to the fluid flow), or several test lanes (e.g., when the individual test lanes run perpendicular to the fluid flow, as shown). Inlets 170, 171, 172, 173, and 174 may each provide a fluid comprising the same analyte (e.g., when each individual test lane comprises a different cell type), or may each provide a fluid comprising a different analyte (e.g., fluid from inlet 170 may contain no analyte (for control purposes), fluid from inlet 171 may contain a peptidic drug candidate, fluid from inlet 172 may contain an oligonucleotide drug candidate, fluid from inlet 173 may contain a small molecule drug candidate, and fluid from inlet 174 may contain an established drug (for comparison purposes).

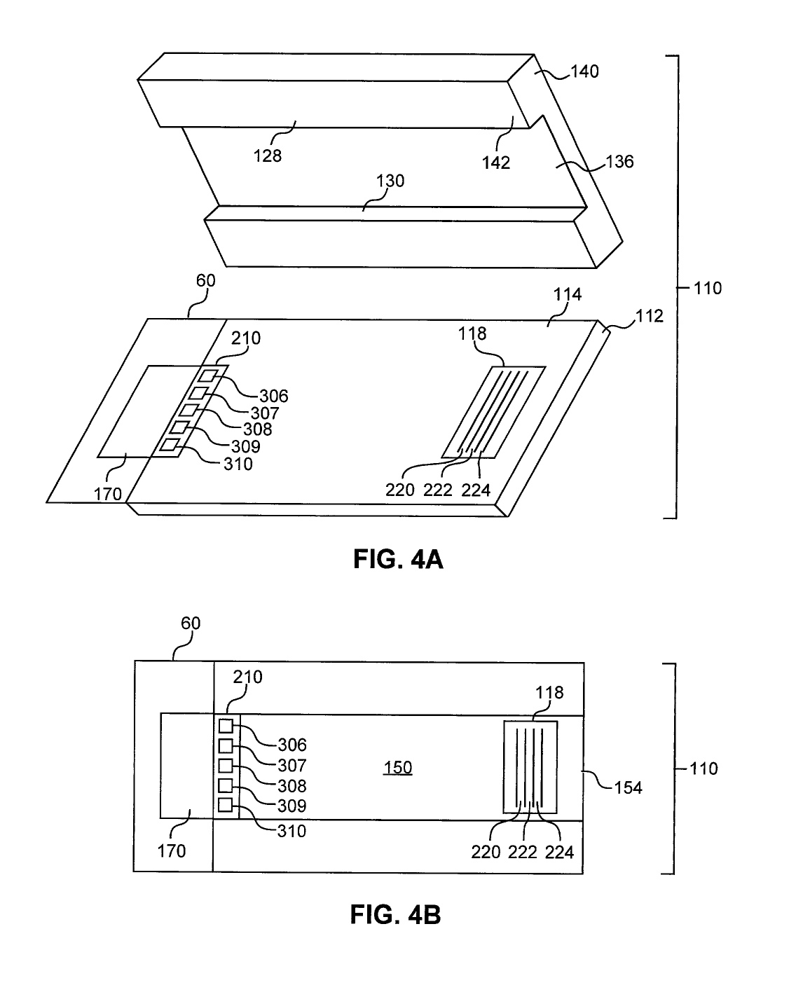

Another technique for effecting controlled delivery of a fluid containing an analyte is illustrated in FIG. 4 and involves providing an analyte source 210 located upstream from the target region 118. The analyte source 210 is adapted to release analyte into the carrier fluid as the carrier fluid flows over the analyte source 210. Thus, when the carrier fluid is maintained in contiguous laminar flow to contact the analyte source 210, analyte is released into the carrier fluid and over the target region. The controlled delivery means 60 as illustrated in FIG. 4 comprises analyte source 210 made up of analyte-containing matrices 306, 307, 308, 309, and 310 on the substrate surface 114 and a means 60 for forming contiguous laminar flow of carrier fluid through the flow passage. As shown, the analyte-containing matrices 306, 307, 308, 309, and 310 are separated from each other. The method and device, however, may incorporate a single analyte-containing matrix, usually as a solid uniform layer affixed to the substrate surface. In either case, the analyte-containing matrix or analyte-containing matrices 306, 307, 308, 309, and 310 are located upstream from the individual test lanes and adapted to release analyte into a carrier fluid as the carrier fluid contacts the analyte-containing matrix or analyte-containing matrices 306, 307, 308, 309, and 310 making up the analyte source 210.

As illustrated in FIG. 4B, once the device is assembled to form a flow passage, a carrier fluid is introduced through the carrier fluid inlet 170 by the controlled delivery means 60 and maintained in contiguous laminar flow through the flow passage 150, over the analyte source 210 and the target region 118, and through the outlet 154. As a result, the carrier fluid fills the entire flow passage 150, contacts the analyte source 210 comprising analyte-containing matrices 306, 307, 308, 309, and 310. As the carrier fluid contacts the analyte source 210, the analyte source 210 releases analyte from the analyte-containing matrices 306, 307, 308, 309, and 310 into the carrier stream, thereby forming individual analyte-containing streams. As a consequence, the carrier fluid conveys analyte over the target region in a specific and narrow lane toward the outlet 154 of the device 110. Again, each fluid lane may contact a single individual test lane (e.g., when the individual test lanes run parallel to the fluid flow), or several test lanes 220, 222, and 224 (e.g., when the individual test lanes run perpendicular to the fluid flow). Also, each concentrated analyte store 306, 307, 308, 309, and 310 may comprise the same analyte or a different analyte. Of course, when the analyte source 210 is in the form of solid uniform layer, the analyte source 210 generally comprises only a single analyte.

When the analyte is a solid, the analyte source 210 (and analyte-containing matrix or matrices) may consist essentially of the analyte as a coating, a pressed pellet, or other solid form. In addition, when the analyte is a solid or non-solid, the analyte may be compounded with an additional material that serves as a binder to form an analyte-containing matrix adapted to controllably release analyte into a carrier upon contact. In such a case, the binder material may swell or be solvated by the carrier to release the analyte into the carrier fluid. When the carrier fluid is aqueous, the binder material may be collagenic or another type of hydrophilic substance such as a hydrophilic polymer. Suitable hydrophilic polymers include, for example: polyalkyleneoxides such as, for example, PEG and polypropylene glycol (PPG); polyvinylpyrrolidones; polyvinylmethylethers; polyacrylamides, such as, for example, polymethacrylamides, polydimethylacrylamides, and polyhydroxypropylmethacrylamides; polyhydroxyethyl acrylates; polyhydroxypropyl methacrylates; polymethyloxazolines; polyethyloxazolines; polyhydroxyethyloxazolines; polyhyhydroxypropyloxazolines; polyvinyl alcohols; polyphosphazenes; poly(hydroxyalkylcarboxylic acids); polyoxazolidines; polyaspartamide; polymers of sialic acid (polysialics); copolymers thereof, and mixtures of any of the foregoing. Such hydrophilic materials may be additionally compounded with a hydrophobic material such as a wax or petroleum jelly to slow the release of the analyte in contact with an aqueous carrier.

The analyte and the binder material may be provided in an appropriate ratio to release the analyte at a constant rate. When the binder material is polymeric, such as one listed supra, the molecular weight of the binder polymer may be selected according to the desired analyte release rate. Typically, higher molecular weight polymers will result in a slower release rate. In addition, it is preferred that the binder material be substantially immobile with respect to the substrate, to avoid release of the binder material downstream if the binder material will interfere with the function of the analyte or a particular assay being conducted. For example, if the binder material has a potential to interfere with the results of an absorption assay being carried out on the substrate, it is preferred that the binder material not be released into the fluid. Thus, to avoid binder material being released into the fluid, the binder material may, for example, be covalently bound to the substrate surface. In some instances, the binder material may be appropriate as both a binder material for the analyte source as well as a material used to immobilize cells. For example, collagenic materials may both immobilize cells within individual test lanes as well as assist in controlling the release of an analyte into the carrier fluid.

When a plurality of different analytes are desired, individual streams, each containing a different analyte, may be formed. In such a case, the method and device typically involve providing a fluid vessel having a cavity extending from an inlet opening to an outlet opening and loading a plurality of fluids, each containing a different analyte, released sequentially through the inlet opening into the cavity. The sequence is selected to correspond to the desired sequence with which the analyte streams will be created. The loaded fluid is expelled through the outlet opening and out the vessel to sequentially produce a stream of fluid containing the desired analyte. For small volumes of fluid, the fluid vessel may be a capillary tube. Optimally, the vessel contains discontinuities in fluid, e.g., bubbles, such that separation is achieved between each analyte sample.

The sequential loading of the vessel with fluid containing different analytes may be carried out using manual or automated fluid handling devices. For example, the wells in microtiter well plates having 96, 384, or 1536 wells may each contain a different analyte. A quantity of fluid may be withdrawn from each well and loaded in sequence into the inlet opening of a capillary tube. Pressure may then be applied to the inlet opening through any of a number of pressure generating means (e.g., syringe, micropump, etc.) to eject a stream of fluid containing the desired analyte.

As discussed above, the flow passage is typically defined in part by a cover plate that opposes the target region of the substrate surface. Often, the cover plate surface is parallel to the target region of the substrate surface. Similarly, it is preferred that the flow passage of the device is constructed as a conduit. Accordingly, the flow passage is typically defined by opposing side walls in fluid-tight contact with the substrate. In some instances, the side walls represent an integral portion of the substrate. When the flow passage is a conduit having a constant cross-sectional shape and area, formed lanes are substantially parallel to each other and to the conduit walls. One skilled in the art will recognize that lanes may be narrowed if the conduit is narrowed.

Similarly, the optional cover plate and substrate surfaces may or may not be parallel to each other. As analytes and fluids that may be employed with the invention may be rare or expensive, it is preferred that as little analyte and fluid be used to flow over the target region as is practicable. However, fluid flow depends on the volume of analyte or fluid as well as the volume of the flow passage. Typically, when the substrate and cover plate surfaces are parallel to each other, the surfaces are located from about 1 μm to about 500 μm from each other. Preferably, the substrate and cover plate surfaces are located from about 20 μm to about 100 μm from each other.

For any of the embodiments described above, it is preferred that the device be constructed in a modular manner to ensure the interchangeability of the components. In particular, certain components may be formed from stock items to lower the cost of the device, and to make it cost effective to treat at least the stock components as disposable. For example, as discussed above, the substrate may comprise a glass slide as found in most laboratories and available commercially from, for example, Sigma-Aldrich Corp, St. Louis, Mo. (product number S 8902). Similarly, to facilitate handling, the components of the inventive device may be detachable from each other. As access to the target region of the substrate is limited when it is in an opposing relationship to the cover plate, it is preferred that the substrate be detachable from the cover plate. When the substrate is a detachable and disposable item such as glass slide, complex capillary tube attachment procedures may be avoided before each use of the device when the tubes are essentially permanently connected to the inlets.

The device may be adapted to form analyte streams from fluids of virtually any type depending on the intended assay. Thus, the fluid may be aqueous and/or nonaqueous. Nonaqueous fluids include, for example, organic solvents and lipidic liquids.

Since fluid laminar flow is a function of a number of variables, such as the geometry of the surfaces over which the fluid flows, flow velocity, and fluid properties such as viscosity, it is important that fluid movement in the inventive device be precisely controlled. Inlets through which fluids containing analyte are introduced into the flow passage typically have a cross sectional area of 1×10⁻⁵ mm² to about 1 mm², preferably about 5×10⁻⁴ mm² to about 0.1 mm², and optimally 1×10⁻³ mm² to about 1×10⁻² mm². The inlets may have a variety of shapes including, but not limited to, circular, elliptical, square, rectangular, and triangular.

In order to ensure that laminar flow is exhibited in the fluid flowing through the flow passage, a pump is employed to deliver appropriate fluid from a fluid source through the appropriate inlet. Typically, high precision microsyringe pumps are employed to provide fluid flow through capillaries to the inlets. However, other types of pumps may be employed as well. In some instances, one pump is sufficient to provide a motive force to ensure proper fluid flow.

It should be noted that a fluid exhibiting laminar flow over the test lane may be employed to attach moieties, e.g., analyte, reagents, cells, and so forth, to a desired area on the substrate. That is, fluid flowing over a desired area on the substrate delivers the moiety to the desired area, thereby allowing for attachment of the moiety to the substrate. The moiety may be attached to the substrate based on techniques known to those skilled in the art, e.g., using a functionalized substrate or a substrate that exhibits surface modification. For example, antibodies may be bound to the substrate so that proteins that contact the bound antibodies immobilize the proteins. Optimally, moiety binding to the substrate is covalent in nature, although other types of binding, e.g., ionic, hydrogen, and so forth, may also be used.

After the analyte is allowed to contact the immobilized cells, the method involves detecting a change, or lack thereof, in the immobilized cells, the analyte, or both, resulting from the contact. Detectable changes in the cell include, but are not limited to, changes in the cell size, cell shape, cell color, protein expression, organelle arrangement (i.e., arrangement of the endoplasmic reticulum, mitochondria, nucleus, nucleolus, vacuoles, and so forth, within a cell), intracellular pH, intracellular activities of ions (e.g., Ca²⁺ and/or Cl⁻), cellular uptake of moieties (e.g., analytes, dyes, or labeled analytes), and chromosome number (as a result of mitosis or meiosis).

Detectable changes in the analyte include chemical changes resulting from metabolism by a cell. Such metabolic changes are generally classified into phase I reactions and phase II reactions. Detectable phase I reactions include oxidative, reductive, and hydrolytic biotransformations. Representative oxidative reactions include, without limitation: oxidation of aromatic moieties; oxidation of olefins; oxidation at benzylic or allylic carbon atoms, and carbon atoms α to carbonyl and imines; oxidation at aliphatic and alicyclic carbon atoms; oxidation involving carbon-heteroatom systems, such as oxidation of carbon-nitrogen systems (e.g., N-dealkylation, oxidative deamination, N-oxide formation, and N-hydroxylation), oxidation of carbon-oxygen systems (e.g., O-dealkylation), oxidation of carbon-sulfur systems (e.g., S-dealkylation, S-oxidation and desulfuration); and oxidation of alcohols and aldehydes. Representative reduction reactions include, but are not limited to reduction of aldehydes and ketones as well as reduction of nitro and azo compounds. Representative hydrolytic reactions include hydrolysis of esters and amides and hydration of epoxides and arene oxides by epoxide hydrase. Detectable phase II reactions include, but are not limited to, glucuronic acid conjugation, sulfate conjugation, conjugation with amino acids (e.g, glycine or glutamine) or glutathione (mercapturic acid), acetylation, and methylation. As will be appreciated, some of these above reactions, e.g., hydrolysis, may occur spontaneously in the carrier fluid. By including a control stream that does not contact cells, however, it is possible to subtract the amount of “noncell-mediated” hydrolysis from the amount of hydrolysis determined for a stream that did contact cells.

A means for detecting a change is used to detect changes in the immobilized cells, the analyte, or both. Such a means may advantageously be a part of the devices described herein, thereby providing a single apparatus for facile testing of one or more analytes. While the detecting means will vary depending upon the assay being conducted and the potential signal being produced, one skilled in the art will readily identify those detectors suitable for any particular assay and signal. Furthermore, the change in the analyte, the cells, or both may be conducted by inspecting the cells directly on the substrate or by removing them, e.g., by scraping the slide. Also, the fluid outflow may be assayed, as metabolized analytes will often be released from the cells back into the carrier fluid.

Often, a label previously attached to the analyte may be used to provide a detectable signal. Labeled analytes are commercially available. In addition, an analyte may be labeled using conventional labeling techniques such as coupling the analyte with a commercially available activated label, e.g., fluorescein isothiocyanate. Other labeling techniques known in the art may also be used.

The label may be a radioactive label, e.g., ³H, ¹³C, ¹⁴C, ³²P, ¹²⁵I, ¹³¹I, ³⁵S, or ¹⁵N, a fluorescer (e.g., fluorescein and its fluorescent derivatives, phycoerythrin, allo-phycocyanin, phycocyanin, rhodamine, or Texas Red), a dye (e.g., ethidium bromide, acridines, propidium, or pyrene maleimide), a chemiluminescer, a photosensitizer, or an enzyme, enzyme substrate or affinity label (e.g., biotin, peroxidase, or alkaline phosphatase). Scintillation counters, gamma counters, autoradiographers, films, nuclear magnetic resonance (NMR) devices, infra-red (IR) detectors, fluorimeters, luminometers, and spectrophotometers are able to detect these or other labels. Of course, some labels may require the addition of another moiety, e.g., substrate, enzyme or binding partner, for facile detection.

Labels, however, are not always required for detecting a change in the immobilized cells, the analyte, or both. Detectors such as an optical imaging system or a microscope can detect changes in an immobilized cell. Other detectors include, for example, chromatographic devices, mass spectrometers, immunoassays, fluorescence detectors, and combinations thereof. In addition, any combination of detectors and/or labels may be used for detecting a change in a cell, an analyte, or both.

Once a change, if any, is detected, the change must be correlated to an absorption, distribution, metabolism and/or excretion property of the analyte. It will be readily appreciated that the absence of a change may also correlate with such properties. Correlating the detected change (or lack of change) to one or more ADME properties is based on the particular assay performed, which, in turn, is based on the type of cell being placed in contact with the analyte. Thus, for example, the presence of an analyte in a gastrointestinal cell is indicative of an analyte that may be systemically absorbed, as gastrointestinal cells serve as an initial boundary for systemic absorption; such a change in this cell may correlate to absorption. The presence of an analyte in a brain microvascular endothelial cell is indicative of an analyte that may be distributed into the brain as brain microvascular endothelial cells serve as a “blood-brain barrier” in the body; such a change in this cell correlates to distribution. Chemical and structural changes in an analyte that has contacted a hepatocyte (liver cell) are indicative of metabolism, as hepatoctyes metabolize xenobiotics in the body; such a change in the analyte correlates to metabolism. The presence of an analyte in a kidney cell indicates that the analyte may be voided by renal excretion, as xenobiotics must travel through kidney cells to appear in the urine; such a change in the cell may correlate to excretion. Of course, the lack of a change is also indicative of a lack of absorption, a lack of distribution, a lack of metabolism, and/or a lack of excretion. As will be appreciated by one of skill in the art, additional assays based on different cellular models may also be used in the present method and incorporated in the present device. For example, the effect of the analyte on the cytochrome P-450 family of enzymes may be evaluated using hepatocytes.

Preferably, the carrier fluid, including any other fluid flowing through the flow passage, comprises a culture medium or perfusion solution, e.g., Hank's balanced salt solution (HBSS), for sustaining the viability of the cells, in addition to providing directionality to the stream of fluid containing the analyte. It must be noted, however, that the fluid or fluids flowing through the flow passage do not necessarily ensure that the cells remaining living, although living cells are preferred. Thus, for example, the fluid or fluids may be provided to keep living cells viable in the absence of a toxic analyte. If a toxic analyte is introduced into the carrier fluid during the assay, cell death may result notwithstanding the presence of the culture medium or perfusion solutions.

Culture media suitable for the cells immobilized on the substrate are known to those skilled in the art and are available commercially from, for example, Sigma Inc., St. Louis, Mo. Generally such media contain mixtures of salts, amino acids, vitamins, nutrients, and other substances necessary to maintain cell health. Preferred salts in the culture medium include, without limitation, NaCl, KCl, NaH₂PO₄, NaHCO₃, CaCl₂, MgCl₂, and combinations thereof. Preferred amino acids are the naturally occurring L amino acids, particularly arginine, cysteine, glutamine, histidine, isoleucine, leucine, lysine, methionine, phenylalanine, threonine, tryptophan, tyrosine, valine, and combinations thereof. Preferred vitamins in the culture media include, for example, biotin, choline, folate, nicotinamide, pantothenate, pyridoxal, thiamine, riboflavin, and combinations thereof. Glucose and/or serum, e.g., horse serum or calf serum, are also preferred components of the culture medium. Optionally, antibiotic agents such as penicillin and streptomycin may be added to suppress the growth of bacteria. Preferably, the culture medium will contain one or more protein growth factors specific for a particular cell type. For example, many nerve cells require trace amounts of nerve growth factor (NGF) to sustain their viability. Similarly, the culture medium may preferably contain hepatocyte growth factor (HGF) when hepatocytes are present in the assay. Those skilled in the art routinely consider these and other factors in determining a suitable culture medium for any given cell type.

In addition, the carrier fluid or other fluid flowing through the device may contain buffers or perfusion solutions such as Hank's balanced salt solution, with or without the culture medium. Those of skill in the art will recognize other suitable buffers and solutions for use with the present methods and devices.

The analyte in the carrier fluid may exist in a solvated form, partially solvated form, or suspended form. Whether any particular analyte will be solvated, partially solvated or suspended in any particular carrier fluid is dependent upon the properties of both the analyte and the carrier fluid. Generally, aqueous-soluble analytes, e.g., hydrophilic drugs, will be in solvated or partially solvated in aqueous carrier fluids while nonaquous-soluble analytes, e.g., hydrophobic analytes, will be only partially solvated or suspended in aqueous carriers.

Nearly any type of cell may be used with the present methods, including both eukaryotic and prokaryotic cells. Preferably, however, the cell is a primary mammalian cell, e.g., a human cell. Preferred cell types are selected from the group consisting of blood cells, stem cells, endothelial cells, epithelial cells, bone cells, liver cells, smooth muscle cells, striated muscle cells, cardiac muscle cells, gastrointestinal cells, kidney cells, nerve cells, and cancer cells. Particularly preferred cells include liver cells, gastrointestinal cells, endothelial cells, e.g., brain microvascular endothelial cells, and kidney cells. The cells may originate from a cell line.

Generally, the total number of cells used in any one assay will be from about 2 cells to about 5,000 cells, more preferably from about 2 cells to about 1,000 cells, and most preferably from about 2 cells to about 500 cells.

Typically, immobilized cells are present on the target region as a confluent or subconfluent monolayer within each test lane. The monolayer within each test lane may be substantially contiguous or comprise an array of features, each feature comprising at least one cell. All of the cells within any single test lane are of the same type. The cells may be immobilized onto the solid surface using conventional techniques known to those skilled in the art. For example, the cells may be immobilized within any one test lane by simply contacting the cells to the test lane. Areas and/or test lanes where the cell type is not desired may be protected with a covering, e.g., adhesive tape, which is removed once all cells have been added to the substrate. Cells that may already be located on the substrate may be protected by, for example, cover slips suitably shaped to protect the area containing the immobilized cells. Optionally, a centrifuge may be used. Generally, the force required to immobilize the cell on the target region is from about 200×g to about 500×g.

The cells may be immobilized on the substrate prior to incorporating the substrate into the device. In addition, cells may be immobilized to a substrate incorporated within the device by introducing the cells via the same inlet and manner used to introduce the analyte.

In addition, the substrate surface may be coated with a layer of a cell-adhering substance such as any biological molecule that can facilitate attachment of a living cell. Examples of such substances include collagen, alginate, agar, or other material used to immobilize the cells. Preferably, the cell-adhering substance is shaped to provide individual test lanes. When immobilization of cells in a contiguous layer within a test lane is desired, the cell-adhering substance may be contiguously coated on the test lane. However, when it is desirable to provide an immobilized array of cells, the cell-adhering substance may be present as an array of features on the target region. That is, an array of locations on the target region may be coated with an appropriate material to form an array, e.g., checkerboard, spots or other pattern, so that cells may be spatially arranged at specific locations on the solid surface. See, e.g., U.S. Pat. Nos. 5,976,826 and 5,776,748 to Singhvi. In some instances, a photolithographic technique may be employed. U.S. Pat. Nos. 5,202,227 and 5,593,814 each to Matsuda et al. describe a process for preparing a cell arrangement control device wherein a photosensitive, cell-nonadhesive polymer is applied to a cell adhesive surface. The resulting photosensitive cell-nonadhesive polymer layer is irradiated patternwise and developed to leave the irradiated portion on the cell-adhesive surface, thereby providing a pattern of the cell-nonadhesive polymer on the cell adhesive surface. As a result, a biological cell culture device may include a surface pattern having a cell-adhesive portion and a cell-nonadhesive portion, wherein the cell-nonadhesive portion is covalently bound to the cell adhesive surface.

The cells may be present on the target region as a tissue section. Immobilization of tissue sections containing cells of interest may be accomplished by first freezing, e.g., to about −15° C. to about −20° C., a relatively large section of tissue. Thereafter, a knife, microtome, or similar sectioning device is used to slice the frozen tissue into sections of desired shape, e.g., lanes. Next, a single section of the tissue is placed onto the target region, e.g., a glass slide, and the section is allowed to “melt” on the target region, thereby immobilizing cells in the tissue onto the target region. Those skilled in the art will recognize other immobilization techniques that can be used as well.

Thus, the multiplex assays described herein are useful for determining ADME properties of an analyte. The analyte may be a drug, drug candidate, or experimental reagent, wherein the present method and device provide the ability to screen a single or plurality of analytes against a single or plurality of different cell-based ADME models. In addition, the analyte may comprise a pharmaceutical excipient or pharmaceutical excipient candidate optionally combined with a drug or drug candidate so that altered ADME properties, e.g., increased absorption, in the presence of the excipient may be evaluated. The method and device are not limited with respect to the particular analyte used. Preferably, the analyte is selected from the group consisting of a small drug molecule, amino acid, amino acid analog, peptide, protein, nucleotide, nucleoside, oligonucleotide, antibody, or a conjugate thereof.

Variations of the present invention will be apparent to those of ordinary skill in the art. For example, while a channel may be provided on a cover plate or base surface, as described above, the channels may be instead located in the substrate surface. Also, the side walls may include inlets and controlled delivery means for introducing cells, reagents, or analyte, such that features, e.g., test lanes containing different cell types, can be added in a facile manner in a direction perpendicular (i.e., “Y lanes”) to the analyte-flow direction prior to conducting the assay. In addition, the inventive device may be employed to carry out biomolecular assays by immobilizing biomolecules in place of cells on the target region. In addition, while several techniques have been described for the controlled delivery of a carrier fluid, these techniques are provided as examples only, and other techniques that incorporate a combination of different aspects of the techniques described herein may be employed as well.

It is to be understood that while the invention has been described in conjunction with the preferred specific embodiments thereof, the foregoing description is intended to illustrate and not limit the scope of the invention. Other aspects, advantages, and modifications within the scope of the invention will be apparent to those skilled in the art to which the invention pertains.

All patents, patent applications, and publications mentioned herein are hereby incorporated by reference in their entireties.

### EXPERIMENTAL

The practice of the present invention will employ, unless otherwise indicated, conventional techniques of the analytical industry and the like, which are within the skill of the art. Such techniques are explained fully in the literature.

In the following example, efforts have been made to ensure accuracy with respect to numbers used (e.g., amounts, temperature, etc.) but some experimental error and deviation should be accounted for. Unless indicated otherwise, temperature is in degrees Celsius and pressure is at or near atmospheric. All reagents were obtained commercially unless otherwise indicated.

### Example 1

A device similar to that illustrated in FIG. 2. is used to investigate the expected ADME properties of a small molecule peptidomimetic drug. Primary cultures of human small intestinal cells, or Caco-2 (a human intestinal carcinoma cell line) pretreated with 1α,25-dihydroxyvitamin D₃ (which expresses cytochrome P450 IIIA4; see Schmiedlin-Ren et al. (1997) Mol. Pharmacol. 51(5):741-754) is grown on the substrate surface. Eight individual lanes are drawn in the on the surface of the cultured cells with different perfusion solutions. The perfusion solutions in these lanes are formulated as follows: lane-1 solution contains Calcien/AM (P-glycoprotein substrate) without the test drug; lane-2 solution contains Calcien/AM plus the test drug at a selected concentration; lane-3 solution contains CellTracker Green CMFDA or monochlorobimane (to measure the glutathione S-conjugate of the fluorogenic reagent, which is substrate of MRP-2) without the test drug; lane-4 solution contains CellTracker Green CMFDA (5-chloromethylfluorescein diacetate) (or monochlorobimane) plus the test drug; lane-5 solution contains the intracellular pH indicator BCECF (2′,7′-bis(2-carboxyethyl)-5,6-carboxyfluorescein) without the test drug; lane-6 solution contains BCECF plus the test drug; lane-7 solution contains dibenzylfluorescein (DBF; fluorogenic indicator of cytochrome P450 metabolite) without the test drug; lane-8 solution contains DBF plus the test drug. After the cells in each lane are pretreated separately with the above experimental perfusion solutions for appropriate time period, the perfusion solutions are washed out and replaced with fresh HBSS solution. Exposed to the appropriate wavelength of excitation light, the cells in each lane are examined under a fluorescence microscope. Fluorescence images of the cell monolayer are taken by an imaging system. The fluorescence signals in the selected areas of each lane are quantified and analyzed by imaging software. No changes in fluorescence signals are detected between lanes 1 and 2, between lanes 3 and 4, and between lanes 7 and 8. These data suggest that the test compound is not a substrate of P-glycoprotein or of MRP-2. The data also show that the test drug does not interfere with the metabolic activity of P450 IIIA4, suggesting that the test compound is not a substrate of this P450 isoenzyme. It is also found that addition of the test drug (in lane 6) caused a marked decrease in intracellular pH compared with the cells immobilized in lane 5, suggesting that the test drug is transported into the intestinal cells via a proton-coupled oligopeptide transporter.

What is claimed is:

1. A method for conducting a multiplex assay for determining absorption, distribution, metabolism, and/or excretion properties of an analyte, comprising:
(a) providing a device comprising (i) a substrate having a plurality of substantially parallel individual test lanes on the surface thereof, wherein each test lane comprises a plurality of living cells immobilized therein, and the living cells within any one test lane are of the same type, (ii) at least one inlet for introduction of a carrier fluid into the device, (iii) a means for controlling delivery of the carrier fluid onto and across the substrate surface, and (iv) an analyte source for introducing the analyte into the carrier fluid;
(b) introducing the analyte from the analyte source to at least one test lane by controlled delivery of a carrier fluid containing the analyte so that the analyte is maintained by laminar flow within a predetermined flow path, thereby contacting the living cells immobilized in at least one of the test lanes;
(c) detecting a change, when present, in the immobilized cells, the analyte, or both, resulting from the contact; and
(d) correlating any change detected in (c), or lack thereof, to an absorption, distribution, metabolism, and/or excretion property of the analyte.

2. The method of claim 1, carried out with multiple analytes.

3. The method of claim 2, wherein steps (b), (c) and (d) are repeated with multiple analytes.

4. The method of claim 2, wherein the carrier fluid containing the analyte flows in a direction substantially perpendicular to the test lanes.

5. The method of claim 2, wherein the carrier fluid containing the analyte flows in a direction substantially parallel to the test lanes.

6. The method of claim 1, carried out with a single analyte and wherein each test lane contains different cells with respect to the other test lanes.

7. The method of claim 6, wherein the carrier fluid containing the analyte flows in a direction substantially perpendicular to the test lanes.

8. The method of claim 6, wherein the carrier fluid containing the analyte flows in a direction substantially parallel to the test lanes.

9. The method of claim 1, wherein the living cells are immobilized as a confluent monolayer within each test lane.

10. The method of claim 1, wherein the living cells are immobilized as a subconfluent monolayer within each test lane.

11. The method of claim 1, wherein the living cells are primary cells.

12. The method of claim 11, wherein the primary cells are mammalian.

13. The method of claim 1, wherein the living cells immobilized in at least one test lane are selected from the group consisting of blood cells, stem cells, endothelial cells, epithelial cells, bone cells, liver cells, smooth muscle cells, striated muscle cells, cardiac muscle cells, gastrointestinal cells, kidney cells, nerve cells, and cancer cells.

14. The method of claim 13, wherein the living cells immobilized in at least one test lane are selected from the group consisting of liver cells, gastrointestinal cells, endothelial cells, and kidney cells.

15. The method of claim 14, wherein the cells are liver cells.

16. The method of claim 14, wherein the cells are endothelial cells.

17. The method of claim 16, wherein the endothelial cells are brain microvascular endothelial cells.

18. The method of claim 1, wherein the analyte is selected from the group consisting of drugs, drug candidates, pharmaceutical excipients, pharmaceutical excipient candidates, and combinations thereof.

19. The method of claim 1, wherein the analyte is selected from the group consisting small drug molecules, amino acids, amino acid analogs, peptides, proteins, nucleotides, nucleosides, oligonucleotides, antibodies, and conjugates thereof.

20. The method of claim 2, wherein each of the multiple analytes is independently selected from the group consisting of drugs, drug candidates, pharmaceutical excipients, pharmaceutical excipient candidates, and combinations thereof.

21. The method of claim 2, wherein each of the multiple analytes is independently selected from the group consisting small drug molecules, amino acids, amino acid analogs, peptides, proteins, nucleotides, nucleosides, oligonucleotides, antibodies, and conjugates thereof.

22. The method of claim 1, wherein the analyte is contained in the carrier fluid in solvated form.

23. The method of claim 1, wherein the analyte is contained in the carrier fluid in partially solvated form.

24. The method of claim 1, wherein the analyte is contained in the carrier fluid in suspended form.

25. The method of claim 1, wherein the analyte is coupled to a label.

26. The method of claim 25, wherein the label is selected from the group consisting of fluorescers, radiolabels, enzymes, enzyme substrates, chemiluminescers, dyes, and photo sensitizers.

27. The method of claim 1, wherein the substrate is made from glass.

28. The method of claim 1, wherein the carrier fluid comprises a medium appropriate to sustaining living cells.

29. The method of claim 1, wherein in the change detected in step (c) is absorption of the analyte by at least one of the plurality of cells.

30. The method of claim 1, wherein the change detected in step (c) is metabolite formation.

31. The method of claim 1, wherein no change is detected in step (c).

32. The method of claim 1, wherein the substrate comprises at least 3 test lanes.

33. The method of claim 32, wherein the substrate comprises at least 10 test lanes.

34. The method of claim 1, wherein the analyte is introduced via hydrodynamically focused flow.

35. The method of claim 2, wherein multiple analytes are each introduced via hydrodynamically focused flow.

36. The method of claim 35, further comprising in step (a): providing a fluid vessel having a cavity extending from an inlet opening to an outlet opening; sequentially loading multiple fluids, each fluid containing a different analyte; sequentially releasing through the inlet opening into the cavity, wherein the sequence is selected to correspond to a predetermined release sequence of the analyte; and expelling the loaded fluid through the opening and out the vessel to produce a stream of fluid that exhibits the predetermined release sequence.

37. The method of claim 1, wherein the analyte is introduced via a plurality of introduction channels, each associated with an individual analyte outlet.

38. The method of claim 2, wherein each of the multiple analytes is individually introduced via a plurality of dedicated introduction channels, each introduction channel associated with an individual analyte outlet.

39. The method of claim 1, wherein the analyte is introduced via an analyte-containing matrix located upstream from the test lanes and adapted to release analyte into the carrier fluid as the carrier fluid flows over the analyte-containing matrix.

40. The method of claim 2, wherein each of the multiple analytes is individually introduced via a plurality of analyte-containing matrices, each located upstream from the test lanes and adapted to release each of the multiple analytes into the carrier fluid as the carrier fluid flows over each of the analyte-containing matrices.

41. A device for conducting a multiplex assay for determining absorption, distribution, metabolism, and/or excretion properties of an analyte, comprising:
(a) a substrate having a plurality of substantially parallel individual test lanes on the surface thereof, wherein each test lane comprises a plurality of living cells immobilized therein, and the living cells within any one test lane are of the same type;
(b) at least one inlet for introducing a carrier fluid into the device so as to enable contact between the carrier fluid and the substrate surface;
(c) an analyte source for introducing the analyte into the carrier fluid;
(d) a means for controlling delivery of the carrier fluid so as to enable the analyte to be maintained by laminar flow within a predetermined flow path, thereby providing for contact of the living cells immobilized in at least one of the test lanes; and
(e) at least one outlet enabling removal of fluid from the device.

42. The device of claim 41, further comprising a means for detecting a change, or lack thereof, in the immobilized cells, the analyte, or both, resulting from the contact of the living cells with the analyte.

43. The device of claim 41, wherein the means for detecting a change is selected from the group consisting of optical imaging systems, microscopes, chromatographers, mass spectrometers, immunoassays, fluorescence detectors, scintillation counters, gamma counters, autoradiographers, films, nuclear magnetic resonance devices, infra-red detectors, and spectrophotometers.

44. The device of claim 41, further comprising a fluid vessel having a cavity extending from an inlet opening to an outlet opening for loading multiple fluids, each fluid containing a different analyte in a sequence through the inlet opening into the cavity.

45. The device of claim 41, further comprising a flow passage.

46. The device of claim 45, wherein the flow passage is further defined by a cover plate having a surface that opposes the surface of the substrate.

47. The device of claim 41, wherein the substrate is detachable.

48. The device of claim 41, wherein the substrate is substantially planar.

49. The device of claim 47, wherein the substrate and cover plate surfaces are substantially planar.

50. The device of claim 46, wherein the substrate and cover plate surfaces are located about 1 μm to about 500 μm from each other.

51. The device of claim 50, wherein the substrate and cover plate surfaces are located about 20 μm to about 100 μm from each other.

52. The device of claim 45, wherein the flow passage is further defined by opposing sidewalls in fluid-tight contact with the substrate.

53. The device of claim 52, wherein the sidewalls are substantially parallel to each other.

54. The device of claim 41, wherein the means for controlling delivery of the carrier fluid in laminar flow is adapted to provide constant velocity flow.

55. The device of claim 41, further providing an additional inlet for the introduction of a stream of reagent into the carrier fluid upstream from the test lanes.

56. The device of claim 41, wherein the substrate surface comprises a cell-adhering site.

57. The device of claim 56, wherein the cell-adhering site comprises a biological material that facilitates attachment of a living cell.

58. The device of claim 57, wherein the biological material is collagen.

59. The device of claim 41, wherein the means for controlling delivery of the carrier fluid comprises two guide stream inlets for introducing guide streams, and further wherein the carrier fluid inlet and the guide stream inlets are positioned such that the carrier fluid is interposed between the guide streams.

60. The device of claim 59, wherein the means for controlling delivery of the carrier fluid further comprises means for controlling flow rates of the guide streams such that the carrier fluid is hydrodynamically focused.

61. The device of claim 41, wherein the analyte source comprises a plurality of introduction analyte outlets.

62. The device of claim 41, wherein the analyte source comprises an analyte-containing matrix, wherein the analyte-containing matrix is located upstream from the test lanes and adapted to release analyte into the carrier fluid as the carrier fluid flows over the analyte-containing matrix.

63. The device of claim 62, wherein the analyte source comprises a plurality of analyte-containing matrices, wherein each analyte-containing matrix is located upstream from the test lanes and adapted to release analyte into the carrier fluid as the carrier fluid flows over the analyte-containing matrix.
